(19) United States
(12) Patent Application Publication
(10) Pub. No.: US 2025/0284465 A1
(43) Pub. Date: Sep. 11, 2025

(54) TRUE RANDOM NUMBER GENERATOR AND TRUE RANDOM NUMBER GENERATING METHOD THEREOF

(71) Applicant: Winbond Electronics Corp., Taichung City (TW)

(72) Inventors: Bo-Lun Wu, Taichung City (TW); Chao-Yun Lai, Taichung City (TW)

(73) Assignee: Winbond Electronics Corp., Taichung City (TW)

(21) Appl. No.: 19/026,242

(22) Filed: Jan. 16, 2025

(30) Foreign Application Priority Data
Mar. 6, 2024 (TW) 113108226

(51) Int. Cl. G06F 7/58

(52) U.S. Cl. CPC G06F 7/588

(57) ABSTRACT

A true random number generator and a true random number generating method thereof are provided. The true random number generator includes a random code generating device, a random code storage device, and a memory control circuit. The random code generating device includes multiple first memory cells and is configured to generate a random code. The random code storage device includes multiple second memory cells and is configured to receive and store the random code. The first memory cells are manufactured through a first ion implantation process, and the second memory cells are manufactured through a second ion implantation process. A first implantation energy used in the first ion implantation process is higher than a second implantation energy. used in the second ion implantation process.

### CROSS-REFERENCE TO RELATED APPLICATION

This application claims the priority benefit of Taiwan application serial no. 113108226, filed on Mar. 6, 2024. The entirety of the above-mentioned patent application is hereby incorporated by reference herein and made a part of this specification.

### BACKGROUND

### Technical Field

The disclosure relates to a random number generating technology, and more particularly, to a true random number generator and a true random number generating method used therein.

### Description of Related Art

In recent years, for security purposes, a physical unclonable function (PUF) has been widely used in security product applications. The physical unclonable function is a program that may be used to create a unique random key for a physical entity (e.g., an integrated circuit). Generally speaking, in the physically unclonable function technology, a manufacturing variation of a semiconductor chip is used to obtain a unique random code. Even if the semiconductor chip may be manufactured with precise process steps, the random code thereof is almost impossible to be copied, which may be used in a wide range of applications, such as identities of devices, security, and authentication. Therefore, how to effectively use the physical unclonable function to generate a random code is one of the key points of concern for those in the art.

### SUMMARY

The disclosure provides a true random number generator and a true random number generating method thereof, which may apply disturbance characteristics of specific bits to a physical unclonable function, thereby generating a random code.

A true random number generator in the disclosure includes a random code generating device, a random code storage device, and a memory control circuit. The random code generating device includes multiple first memory cells to generate a random code. The random code storage device includes multiple second memory cells to receive and store the random code. The memory control circuit is coupled to the random code generating device and the random code storage device. The first memory cells are manufactured through a first ion implantation process, and the second memory cells are manufactured through a second ion implantation process. A first implantation energy used in the first ion implantation process is higher than a second implantation energy used in the second ion implantation process.

A true random number generating method in the disclosure is suitable for a true random number generator, including a random code generating device and a random code storage device. The random code generating device includes multiple first memory cells. The random code storage device includes multiple second memory cells. The true random number generating method includes the following. The first memory cells are manufactured through a first ion implantation process. The second memory cells are manufactured through a second ion implantation process. A first implantation energy used in the first ion implantation process is higher than a second implantation energy used in the second ion implantation process. A random code generated by the random code generating device is stored in the random code storage device.

A true random number generator in the disclosure includes a random code generating device. The random code generating device includes multiple memory cells. After a check board bar pattern programming operation is performed, logical values of some of the memory cells are randomly converted from a first logic to a second logic to generate a random code. The memory cells are manufactured through an ion implantation process using ions that are prone to random induction of interference characteristics when being programmed to have a S/D junction with high concentration.

Based on the above, in the true random number generator and the true random number generating method thereof according to the disclosure, the memory cells may be manufactured with a higher implantation energy through process control of the memory cells, thereby increasing the probability of the random induction of interference characteristics for the memory cells. In this way, a random code with random and unique characteristics that may be used as a cryptographic key may be generated, thereby increasing the security of the system device.

In order for the aforementioned features and advantages of the disclosure to be more comprehensible, embodiments accompanied with drawings are described in detail below.

### BRIEF DESCRIPTION OF THE DRAWINGS

FIG. 1 is a schematic block diagram of a true random number generator according to an embodiment of the disclosure.

FIG. 2A is an example of a check board bar (CKBDB) pattern according to an embodiment of the disclosure.

FIG. 2B is an example of a random code according to an embodiment of the disclosure.

FIG. 3 is a schematic diagram of a memory cell according to an embodiment of the disclosure.

FIG. 4A is a schematic diagram of a first bit line according to an embodiment of the disclosure.

FIG. 4B is a schematic diagram of a second bit line according to an embodiment of the disclosure.

FIG. 5 is a flow chart of steps a true random number generating method according to an embodiment of the disclosure.

### DETAILED DESCRIPTION OF DISCLOSED EMBODIMENTS

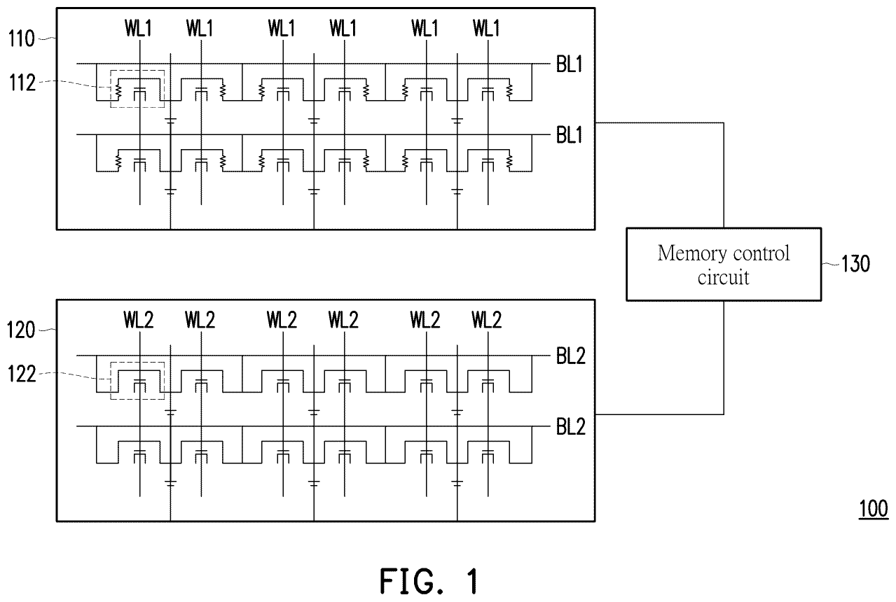

Referring to FIG. 1, a true random number generator 100 in the disclosure includes a random code generating device 110, a random code storage device 120, and a memory control circuit 130. The random code generating device 110 includes multiple first memory cells 112 arranged in an array. The first memory cell 112 is coupled to each of first bit lines BL1 and first word lines WL1.

The random code storage device 120 includes multiple second memory cells 122 arranged in an array. The second memory cell 122 is coupled to each of second bit lines BL2 and second word lines WL2. The second memory cell 122 may be the same non-volatile memory cell as the first memory cell 112, such as a NOR flash memory cell or a NAND flash memory cell. The second memory cell 122 and the first memory cell 112 may be located on the same chip, for example, but processes of the two are different.

The memory control circuit 130 is coupled to the random code generating device 110 and the random code storage device 120. In addition to, for example, a central processing unit (CPU), or other programmable general-purpose or special-purpose microprocessors, digital signal processors (DSP), programmable controllers, application specific integrated circuits (ASIC), programmable logic devices (PLD), or other similar devices or a combinations of these devices, the memory control circuit 130 may also be a hardware circuit designed through a hardware description language (HDL) or any other design method of a digital circuit well known to those with ordinary knowledge in the art, and implemented through a field programmable gate array (FPGA) or a complex programmable logic device (CPLD), etc.

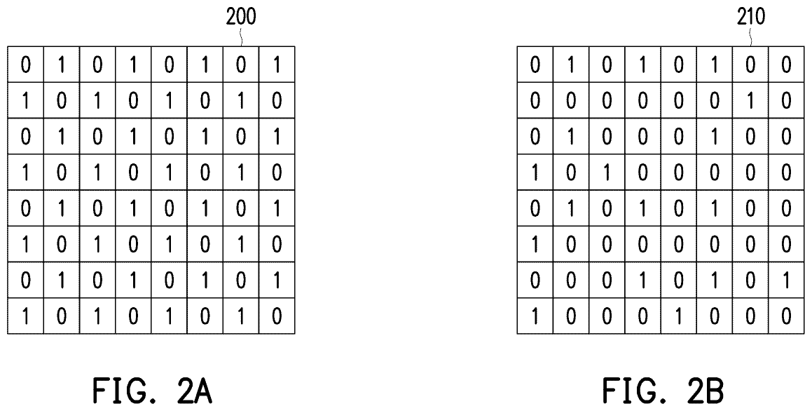

In this embodiment, the memory control circuit 130 may perform a check board bar pattern programming operation on the first memory cell 112 of the random code generating device 110. Specifically, the memory control circuit 130 may sequentially program data corresponding to a check board bar pattern 200 as shown in FIG. 2A into each of the first memory cells 112 from a minimum address. Characteristics of the check board bar pattern are that data of the minimum address is “1”, and data values of two adjacent addresses are different, thereby forming a data pattern of “1010101 . . . ”.

However, the random code generating device 110 is manufactured by a unique first ion implantation process in the disclosure, and is prone to random induction of interference characteristics when being programmed. That is to say, all the first memory cells 112 in the random code generating device 110 are manufactured through the first ion implantation process using ions that are prone to the random induction of the interference characteristics when being programmed. Therefore, after the check board bar pattern programming operation is performed, logic values of some of the first memory cells 112 will be randomly converted from a logic of 1 to a logic of 0, so that the logic values of the first memory cells 112 actually arranged in an array will be, for example, presented as a random code 210 as shown in FIG. 2B. Accordingly, the first memory cells 112 forming the random code generating device 110 has a characteristic of random conversion of bit data, and the random code generating device 110 may generate a random code according to the logic value of the first memory cell 112.

Furthermore, the memory control circuit 130 may store the random code generated by the random code generating device 110 to the random code storage device 120. The random code storage device 120 may be configured to receive and store the random code. In this way, the true random number generator 100 provided in the embodiment of the disclosure may be configured to generate the random code, which may be used as a cryptographic key to increase security of a system apparatus.

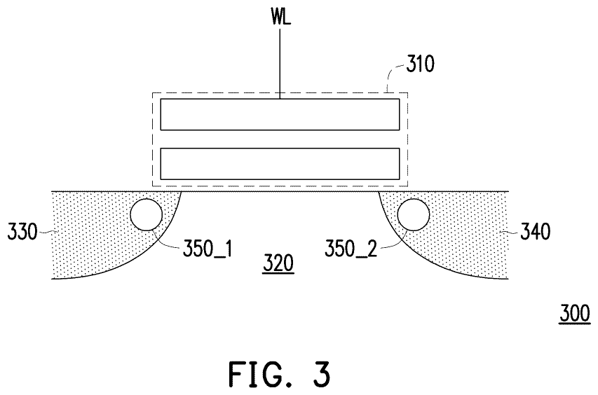

Hereinafter, a memory cell 300 is used to describe schematic structures of the first memory cell 112 and the second memory cell 122. Referring to FIG. 3, the memory cell 300 includes a gate 310, a well region 320, a source 330, and a drain 340. The gate 310 is coupled to a corresponding word line WL. There is a halo region 350_1 at an end of the source 330 close to the gate 310, and there is a halo region 350_2 at an end of the drain 340 close to the gate 310. During fabrication of the memory cell 300, it is generally formed by ion implantation performed in an order of the well region 320, the halo regions 350_1 and 350_2, the source 330, and the drain 340. The structures of the first memory cell 112 and the second memory cell 122 may be regarded as the same as the memory cell 300, for example.

In this embodiment, the first memory cells 112 are manufactured through the first ion implantation process. The second memory cells 122 are manufactured through the second ion implantation process. The first ion implantation process is different from the second ion implantation process. A first implantation energy used in the first ion implantation process is higher than a second implantation energy used in the second ion implantation process.

Specifically, the first ion implantation process includes the following. A halo region of each of the first memory cells 112 is heavily doped with the first implantation energy. The first implantation energy is higher than an energy generally applied when performing the ion implantation on the halo region. The higher the first implantation energy, the higher the randomness of the generated random code. A dopant of the first implantation energy is, for example, a P-type trivalent element, preferably B+. An energy range is, for example, 20 to 50 KeV. An ion concentration range in the halo region is, for example, greater than 1.2E13 cm⁻³, preferably 1.2E13 to 1E14 cm⁻³. However, the disclosure is not limited thereto.

The second ion implantation process includes the following. A halo region of each of second memory cells 122 is lightly doped with the second implantation energy. The second implantation energy is, for example, equal to the energy generally applied when performing the ion implantation on the halo region.

In addition, the first ion implantation process further includes the following. A well region of each of the first memory cells 112 is heavily doped with a third implantation energy. The third implantation energy is higher than an energy generally applied when performing the ion implantation on the well region. The higher the third implantation energy, the higher the randomness of the generated random code. A dopant of the third implantation energy is, for example, a P-type trivalent element, preferably BF₂. An energy range is, for example, 30 to 60 KeV. An ion concentration range in the well region is, for example, greater than 1.5E13 cm⁻³, preferably 1.5E13 to 1E14 cm⁻³. However, the disclosure is not limited thereto.

The second ion implantation process further includes the following. A well region of each of the second memory cells 122 is lightly doped with a fourth implantation energy. The fourth implantation energy is, for example, equal to the energy generally applied when performing the ion implantation on the well region.

Comparing the first memory cell 112 manufactured through the above first ion implantation process to the second memory cell 122 manufactured through the above second ion implantation process, the first memory cell 112 will have a S/D junction with high concentration, the ion concentration range in the halo region thereof is greater than 1.2E13 cm⁻³, and the ion concentration range in the well region thereof is greater than 1.5E13 cm⁻³. Therefore, junction leakage is greater, and a channel boosting level becomes worse, resulting in an increased probability of the random induction of the interference characteristics. In addition, the second memory cell 122 will have a shallower and lighter S/D junction. Therefore, the junction leakage is smaller, and the channel boosting level becomes better, resulting in a lower probability of the random induction of the interference characteristics. In this way, the random code generating device 110 is prone to the random induction of the interference characteristics when being programmed, which may be adapted to generate a random code with high randomness. The random code storage device 120 is adapted to store data (the random code).

It should be noted that since the first memory cell 112 and the second memory cell 122 may be located on the same chip, a mask may be used to shield a region of the second memory cell 122 when the first ion implantation process is performed, and the mask may be used to shield a region of the first memory cell 112 when the second ion implantation process is performed. Compared to conventional process steps, only related steps in which one or two additional masks are added are required to implement the fabrication of the first memory cell 112 and the second memory cell 122, achieving an effect of reducing costs.

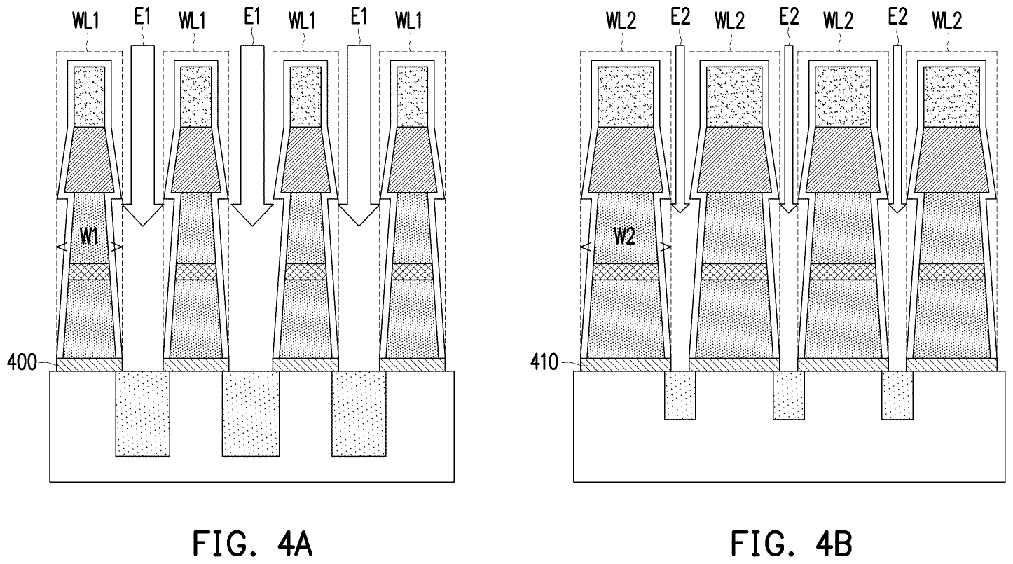

In addition, in an embodiment of the disclosure, the probability of the random induction of the interference characteristics may also be increased by reducing a width of a word line coupled to a memory cell, thereby generating the random code with high randomness. In detail, FIG. 4A is a schematic structure of the first bit line WL1 coupled to the first memory cell 112 in the random code generating device 110, and FIG. 4B is a schematic structure of the second word line WL2 coupled to the second memory cell 122 in the random code storage device 120. Referring to FIGS. 4A and 4B, in FIG. 4A, a width W1 of the first word line WL1 coupled to a gate 400 of the corresponding first memory cell 112 is significantly less than a width W2 of the second word line WL2 coupled to a gate 410 of the corresponding second memory cell 122 in FIG. 4B. That is to say, when the lines are laid out, the width W1 of the first word line WL1 will be laid out to be less than the width W2 of the second word line WL2.

Since the width W1 of the first word line WL1 is smaller, a space between the two first word lines WL1 becomes larger. When the first ion implantation process is performed, a first implantation energy E1 may more easily dope the halo region of each of the first memory cells 112 through the space between the two first word lines WL1, thereby improving an effect of the ion implantation.

In addition, since the width W2 of the second word line WL2 is greater, a space between the two second word lines WL2 becomes smaller. When the second ion implantation process is performed, the second implantation energy E2 is less likely to dope the halo region of each of the second memory cells 122 through the space between the two second word lines WL2, thereby reducing the effect of the ion implantation. In this way, the first memory cell 112 may also have the S/D junction with high concentration, the ion concentration range in the halo region thereof is greater than 1.2E13 cm⁻³, and the ion concentration range in the well region thereof is greater than 1.5E13 cm⁻³, which may also increase the probability of the random induction of the interference characteristics.

Incidentally, the width W2 of the second word line WL2 is, for example, a width of the word line generally coupled the memory cell for storing the data. A ratio range of the width W1 and the width W2 is, for example, 0.95 to 0.8, but the disclosure is not limited thereto.

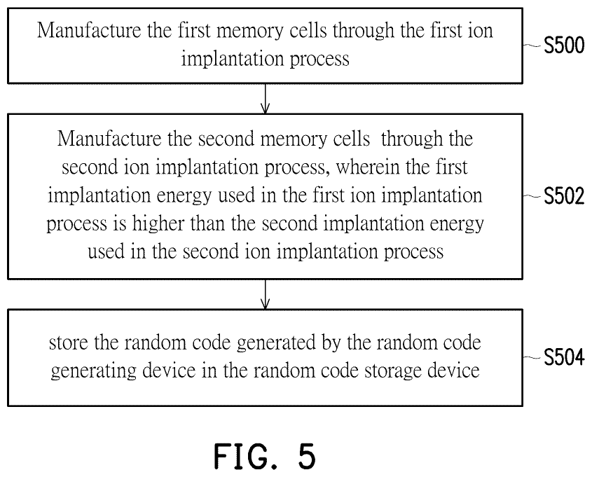

Referring to both FIGS. 1 and 5, a true random number generating method in this embodiment may at least be applied to the true random number generator 100 in the embodiment of FIG. 1, including the following. The first memory cells 112 are manufactured through the first ion implantation process (step S500). The second memory cells 122 are manufactured through the second ion implantation process. The first implantation energy used in the first ion implantation process is higher than the second implantation energy used in the second ion implantation process (step S502). The random code generated by the random code generating device 110 is stored in the random code storage device 120 (step S504). For implementation details of steps S500, S502, and S504, reference may be made to the embodiments of FIGS. 1 to 4A and 4B. Therefore, the same details will not be repeated in the following.

Based on the above, in the true random number generator and the true random number generating method thereof according to the disclosure, the halo region and the well region of the memory cell may be doped with a higher implantation energy through process control of the memory cell. In this way, only related steps in which one or two additional masks are added are required to increase the probability of the random induction of the interference characteristics in the memory cell, thereby generating a random code with random and unique characteristics that may be used as a cryptographic key, thereby increasing the security of the system device.

What is claimed is:

1. A true random number generator, comprising:
a random code generating device comprising a plurality of first memory cells to generate a random code;
a random code storage device comprising a plurality of second memory cells to receive and store the random code; and
a memory control circuit coupled to the random code generating device and the random code storage device,
wherein the first memory cells are manufactured through a first ion implantation process, the second memory cells are manufactured through a second ion implantation process, and a first implantation energy used in the first ion implantation process is higher than a second implantation energy used in the second ion implantation process.

2. The true random number generator according to claim 1, wherein the first ion implantation process comprises:
heavily doping a halo region of each of the first memory cells with the first implantation energy,
the second ion implantation process comprises:
lightly doping a halo region of each of the second memory cells with the second implantation energy.

3. The true random number generator according to claim 2, wherein the first ion implantation process further comprises:
heavily doping a well region of each of the first memory cells with a third implantation energy,
the second ion implantation process further comprises:
lightly doping a well region of each of the second memory cells with a fourth implantation energy, wherein the third implantation energy is higher than the fourth implantation energy.

4. The true random number generator according to claim 1, wherein the first memory cells in the random code generating device are respectively coupled to a plurality of first word lines, the second memory cells in the random code storage device are respectively coupled to a plurality of second word lines, and a width of the first word lines is laid out to be less than a width of the second word lines.

5. The true random number generator according to claim 1, wherein the memory control circuit performs a check board bar pattern programming operation on the first memory cells of the random code generating device, so that the random code generating device generates the random code according to logic values of the first memory cells arranged in an array.

6. A true random number generating method, suitable for a true random number generator, wherein the true random number generator comprises a random code generating device and a random code storage device, the random code generating device comprises a plurality of first memory cells, the random code storage device comprises a plurality of second memory cells, and the true random number generating method comprises:
manufacturing the first memory cells through a first ion implantation process;
manufacturing the second memory cells through a second ion implantation process, wherein a first implantation energy used in the first ion implantation process is higher than a second implantation energy used in the second ion implantation process; and
storing a random code generated by the random code generating device in the random code storage device.

7. The true random number generating method according to claim 6, wherein the first ion implantation process comprises:
heavily doping a halo region of each of the first memory cells with the first implantation energy,
the second ion implantation process comprises:
lightly doping a halo region of each of the second memory cells with the second implantation energy.

8. The true random number generating method according to claim 7, wherein the first ion implantation process further comprises:
heavily doping a well region of each of the first memory cells with a third implantation energy,
the second ion implantation process further comprises:
lightly doping a well region of each of the second memory cells with a fourth implantation energy, wherein the third implantation energy is higher than the fourth implantation energy.

9. The true random number generating method according to claim 6, wherein the first memory cells in the random code generating device are respectively coupled to a plurality of first word lines, the second memory cells in the random code storage device are respectively coupled to a plurality of second word lines, and the true random number generating method further comprises:
laying out a width of the first word lines to be less than a width of the second word lines.

10. The true random number generating method according to claim 6, further comprising:
performing a check board bar pattern programming operation on the first memory cells of the random code generating device such that the random code generating device generates the random code according to logic values of the first memory cells arranged in an array.

11. A true random number generator, comprising:
a random code generating device comprising a plurality of memory cells, wherein after a check board bar pattern programming operation is performed, logical values of some of the memory cells are randomly converted from a first logic to a second logic to generate a random code,
wherein the memory cells are manufactured through an ion implantation process using ions that are prone to random induction of interference characteristics when being programmed to have a S/D junction with high concentration.

12. The true random number generator according to claim 11, wherein the ion implantation process comprises:
heavily doping a halo region of each of the memory cells, wherein an ion concentration range in the halo region of each of the memory cells is greater than 1.2E13 cm⁻³.

13. The true random number generator according to claim 11, wherein the ion implantation process comprises:
heavily doping a well region of each of the memory cells, wherein an ion concentration range in the well region of each of the memory cells is greater than 1.5E13 cm⁻³.
